(19) United States
(12) Patent Application Publication
(10) Pub. No.: US 2023/0311408 A1
(43) Pub. Date: Oct. 5, 2023

(54) Method And Apparatus For Additive Manufacturing

(71) Applicant: Massivit 3D Printing Technologies Ltd., Bet Zmora (IL)

(72) Inventors: Shai Hirsch, Rehovot (IL); Gershon Miller, Rehovot (IL)

(21) Appl. No.: 18/178,585

(22) Filed: Mar. 6, 2023

Related U.S. Application Data
(60) Provisional application No. 63/327,365, filed on Apr. 5, 2022.

(51) Int. Cl. B29C 64/165; B33Y 10/00; B33Y 30/00

(52) U.S. Cl. CPC B29C 64/165; B33Y 10/00; B33Y 30/00; B29L 2023/00

(57) ABSTRACT

Described is a method and apparatus for manufacturing complex-shaped tubular or hollow 3D objects without using a mandrel. Instead of a mandrel, the shape of the composite object is determined locally by a roller that is placed according to the local geometry of the part at the point of layup. The use of rapidly curing resins allows “freezing’ of the composite strip immediately after layup.

### TECHNOLOGY FIELD

The apparatus and method relate to composite materials manufacturing, particularly tubular objects manufactured without using a mandrel.

### BACKGROUND

Composite materials have several advantageous characteristics over traditional metal or plastic materials. In different industries, the use of composite materials is growing fast. The manufacture of three-dimensional hollow objects from composite materials frequently requires a mandrel or mold. Manufacturing the mandrel that shapes the 3D object is expensive, especially for small manufacturing runs. Upon completing the 3D object manufacture, the mandrel can remain inside the finished 3D object or extract from a finished composite object.

A fiber tape or filament could be wound around the mandrel to complete the manufacture of a three-dimensional (3D) object and shape the object according to the mandrel shape. The winding of fiber tape usually follows a spiral pattern. The tape winding with changing winding angles and directions enhances the strength of a manufactured 3D object. The insertion of different strength-enhancing materials could reinforce the tape.

Removing or extracting a mandrel from a 3D object, even with a constant diameter is not a simple task. Most 3D objects have a complex shape that includes curved surfaces with variable curvature, inclined and flat surfaces, and even regular tubes, including segments with changing diameters.

Different techniques facilitating the removal of the mandrel exist. The techniques use inflatable mandrels, mandrels with different thermal expansion coefficients than the material of the 3D object have, soluble mandrels, and mandrels including different easily removable parts. All of these techniques require a mandrel and are therefore bound by or limited in the materials they can use and the shapes they can produce.

### Definitions

Compaction is compressing two materials between two counter-rotating smooth or profiled rollers. If the materials are in the form of tapes or strips, the resulting compaction product could be a solid or flexible tape.

As used in the present disclosure, the teem “winding angle” means the angle between the fiber and the axis of rotation of the manufactured object. The angle could be between zero and ninety degrees.

The term “hoop winding” means a winding angle close to 90 (ninety) degrees. The winding angle affects the directional strength of the manufactured object.

### SUMMARY

Described is a method for manufacturing composite material objects using a flat composite material band. The method includes using a material delivery slit to deliver the flat composite material band through a tensioning roller to a frame. The frame rotates, pulls the composite material band, and wounds the composite material band forming a composite material tubular member.

The first layer of the composite material band is wound at an angle close to 90 degrees. The subsequent layers of the composite material band are wound in a crisscross pattern over the first layer. The first flat band composite material layer serves as a mandrel for the new or additional composite material band layers.

The thickness of the flat composite material band is 0.05 mm to 0.5 mm. The matrix of the flat composite material band includes a rapid curing material. Different composite material band strength enforcement materials such as glass fibers, aramid, and polyethylene could be included in the band. A source of UV curing energy directs the curing energy onto the composite material band to accomplish the material curing process.

The movements of the composite material delivery slit and the tensioning roller are synchronized.

In some examples, optional compaction and a counter-pressure roller could be added to the system. The rollers could be an alternative source for compaction of the composite material band in addition to or as a substitute for the tension resulting from the rotating motion of the frame.

### LIST OF FIGURES AND THEIR SHORT DESCRIPTION

The features and advantages of the disclosure will occur to those skilled in the art the following description and the accompanying drawings, in h identical or similar parts have like referral numbers.

FIG. 1 is a cutaway view of an apparatus for the manufacture of a tubular member according to the present method;

FIG. 2 is a side view of the apparatus for manufacturing a tubular member of FIG. 1;

FIG. 3A is an illustration of the multiple layers of a composite material band;

FIG. 3B is an illustration of an example a composite material band wound at an angle close to 90 degrees to the object axis;

FIGS. 3C and 3D is an illustration of an example a composite material band wound at an angle and in different directions to the object axis; and

FIG. 4 is an example of a modified apparatus to manufacture variable geometry tubular members.

### DESCRIPTION

Removing or extracting a mandrel from a 3D object with a constant diameter requires specific arrangements and jigs. Most 3D objects have a complex shape that includes curved surfaces with variable curvature, inclined and flat surfaces, and even regular tubes, including segments with changing diameters.

The present disclosure provides a method and apparatus for manufacturing complex-shaped tubular or hollow 3D objects without using a mandrel.

Instead of a mandrel, the shape of the composite part is determined locally by a roller that is placed according to the local geometry of the object at the point of layup. The use of rapidly curing resins allows ‘freezing’ of the composite strip immediately after layup. The proposed method and apparatus at least partially utilize the manufactured 3D object to support the manufactured 3D object. The earlier extruded and cured segment of the 3D object serve as a support or mandrel for the manufactured 3D object.

An optional compaction and counter-pressure roller could be added to the system. This roller can be an alternative source for compaction of the strip in addition to or as a substitute for the tension resulting from the rotating motion of the frame.

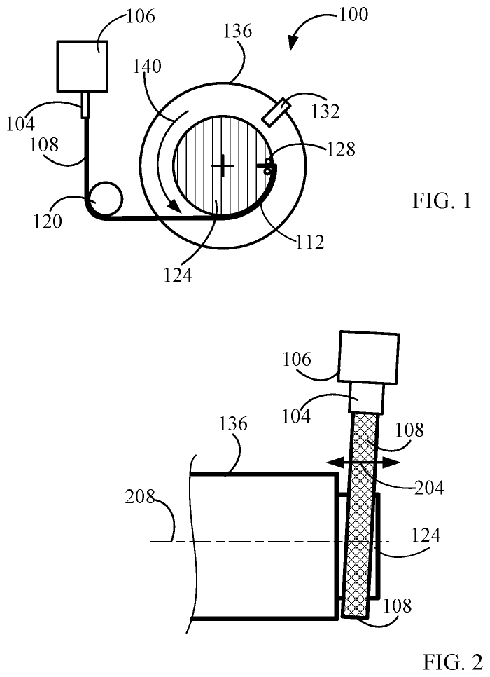

According to the present method, FIG. 1 is a cutaway view of an apparatus for manufacturing a tubular member. Apparatus 100 includes a delivery slit 104 configured to deliver a composite material band or strip 108. Delivery slit 104 delivers a flat composite material band or strip 108 with a thickness of 0.05 mm to 0.5 mm. Flat composite material band or strip 108 could include a matrix of UV curable materials. The UV curable materials could be acrylate-based, and other UV curable materials like epoxy, vinyl-ester, polyester, and hybrid systems such as acrylate/epoxy. The acrylates have the fastest curable rate than other materials have. In the case of reinforced composite material bands, the reinforcement can be any fiber type with sufficient UV penetration: glass fibers, aramid, and polyethylene. Thermoplastic materials also could be used as matrix materials for composite material bands or strips

Strip or band 108 is practically an endless flat band of the composite material. In some examples, the matrix of the endless flat band 108 of the composite material is of rapid curing material. Slit 104 directs the extruded composite material band 108 through a tension roller 120 to a frame 124. Frame 124 includes a pair of lips 128 configured to accept composite material band 108 and, in the course of the band winding process, hold composite material band 108. Reference numeral 106 marks a composite material band supply magazine.

Depending on the material of the matrices of the composite material of band 108, a source of UV curing energy 132 could be used to accomplish band 108 material curing. The source 132 of the UV curing energy could be configured to direct the curing energy on deposited layer 112 of the composite material band 108 wound on frame 124.

The tension applied to strip 108 by tension roller 120 causes strip 108 to lay evenly on the surface 112 of frame 124. Rotation of drum 136 with frame 124, as indicated by arrow 140 also contributes to tensioning of composite material band 108.

The movements of composite material delivery slit 104, tension roller 120, and rotation of frame 124 as illustrated by arrow 204 (FIG. 2) are synchronized. Reference numeral 208 marks the axis of symmetry of the manufactured 3D object.

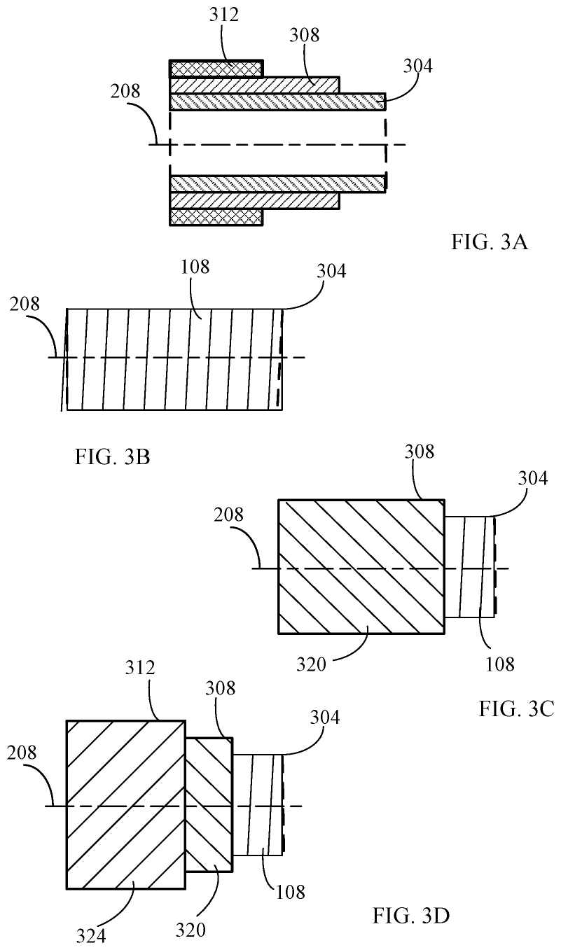

Experiments have indicated that the first (single) applied layers of composite material band 108 could not be sufficiently stiff when the weight of the manufactured 3D object exceeds a certain weight or length. The excessive weight could deform the manufactured 3D object. The first layer 304 (FIG. 3) of the composite material band 108 is wound at an angle close to 90 degrees, for example, 86-89 degrees. Such type of winding is termed hoop winding. The hoop winding enhances the strength of the layer. The hoop winding, where the band of filaments is spun at an almost 90 degrees angle, enhances the strength of the layer and yields a strong burst strength and a relatively smooth finish. Whereas a usual helical layer builds two layers of filaments crisscrossing each other, a hoop layer lays down only one layer. It thus builds only an additional wall thickness related to the thickness of the composite material band.

Each subsequently deposited layer of composite material band 108 enhances the stiffness of the manufactured 3D object. The synchronized movement of tensioning roller 120 facilitates positioning the newly deposited layers of the composite material band 108 cured with the earlier deposited layers of the composite material band 108. FIG. 3A illustrates the multiple layers of a composite material band 108 or a similar one. The multiple or additional layers 308 and 312 of composite material band 108 increase the diameter of the manufactured 3D object. Layers 308 and 312 are wound over earlier deposited hoop layer 304. The movement of the composite material band 108 delivery slit and the rate at which the composite material is deposited could be adjusted to account for the thickness of multiple overlapping layers of the composite material flat band 108.

Laying up of multiple overlapping layers of the flat band composite material 108 or different material increases the manufactured tubular member or 3D object strength. Layers 308 and 312 are wound over earlier deposited hoop layer 304, and in some instances, at least one of the layers could be wound concurrently, maintaining an appropriate distance between the bands 108, 320, and 324. The movement of corresponding slits providing material bands 108, 320, and 324 could be retracted when tubular member thickness becomes sufficient to support the weight of the manufactured tubular member.

When a layer reaches a sufficient thickness, the layup can continue in a different setup (vacuum bag/autoclave). The tubular member 304 acts as a mandrel for the new or additional composite material band. The new or additional composite material band could be identical to band 108 or different, like bands 320 and 324. In some examples, the direction of successive extruded composite material bands or strips 320 and 324 could change the layup direction. For example, composite material band 320 could be wound in the first direction, and composite material band 324 could be wound in a second direction. Composite material bands 320 and 324 angles with axis 208 could be different from each other. The change in the direction produces a stronger tubular member. Typical angles of composite material bands 320 and 324 with axis 208 are +/−45 to +/−60 degrees.

Variable geometry tubular members could be manufactured by controlling the motion of the tension roller according to the required geometry. In some examples, a variable diameter tubular member could be manufactured by a slight modification of the apparatus 100.

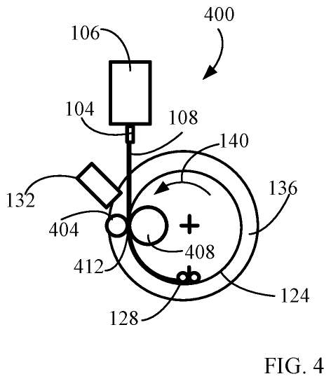

FIG. 4 is an example of a modified apparatus for the manufacture of variable geometry tubular members. Apparatus 400 includes a compaction roller 404 and a counter-pressure roller 408. Compaction roller 404 is an alternative source for compaction of the composite material band 108. The roller acts in addition to or as a substitute to the tension resulting from the rotation motion of the frame. The source 132 of the UV curing energy could be configured to direct the curing energy onto nip 412 between compaction roller 404 and counter-pressure roller 408.

At the end of the manufacturing step, the internal roller can be retracted close to the system axis, allowing for easy removal of the finished part from the manufacturing frame without the need for complex mandrel extraction.

The method and apparatus have been described in detail, and with reference to specific examples thereof, it will be apparent to one of ordinary skill in the art that various changes and modifications can be made to the method and apparatus without departing from the spirit and scope thereof.

What is claimed is:

1. A method for the manufacture of a tubular composite material object comprising:
providing a material delivery slit configured to deliver a composite material band;
a tensioning roller operative to accept and tension the composite material band; and
engaging a frame configured to hold and pull the composite material band,
wherein rotation of the frame wounds the composite material band forming a composite material tubular member.

2. The method of claim 1, wherein the composite material band is a flat band with thickness 0.05 mm to 0.5 mm.

3. The method of claim 1, wherein the material delivery slit delivers an endless flat band of the composite material.

4. The method of claim 3, wherein the flat band of the composite material includes a rapid curing material.

5. The method of claim 1, wherein the movement of the material delivery slit, and movement of the tensioning roller is synchronized.

6. The method of claim 1 further comprises a source of UV curing energy, wherein the UV curing energy source is configured to direct the curing energy onto the composite material band wound on the frame.

7. The method of claim 1, wherein laying up multiple overlapping layers of the composite material flat band.

8. The method of claim 1, wherein a material of the tubular member is one of a group of UV curable materials consisting of acrylate-based, epoxy, vinyl-ester, polyester, and hybrid acrylate/epoxy hybrid systems.

9. The method of claim 1, wherein the tubular member enforcement material consists of glass fibers, aramid, and polyethylene.

10. The method of claim 1, wherein synchronizing material delivery rate with the advances of the tensioning roller and curing source operation.

11. The method of claim 1, wherein the delivery slit is a plurality of slits sequentially operated.

12. The method of claim 1, wherein a delivery rate of the composite material depends on a tubular member dimension.

13. The method of claim 12, wherein adjusting a radial movement of the material delivery slit, accounts for a thickness of multiple overlapping layers of the composite material flat band.

14. The method of claim 1, wherein varying the direction of successive delivered strips of the composite material.

15. The method of claim 1, wherein each new flat band layer acts as a mandrel for the next layer layup.

16. An apparatus for the manufacture of a tubular composite material object comprising:
a head including a composite material delivery slit configured to deliver a composite material band;
a tensioning roller operative to apply pressure to the composite material band; and
a frame operative to accept the composite material band and hold it in the course of tubular member winding;
wherein rotation of the frame wounds the composite material band forming a composite material tubular member.

17. The apparatus of claim 16, wherein the frame accepts the composite material band and rotates to form a composite tubular member.

18. The apparatus of claim 16, wherein the material delivery slit movement and movement of the tensioning roller is synchronized.

19. The apparatus of claim 16 further comprises a source of UV curing energy configured to direct the curing energy onto a composite material layer wound on the frame.

20. The apparatus of claim 16, wherein a rate of the composite material delivery adapted to change in the tubular member dimension.

21. A method for the manufacture of a tubular composite material object, comprising:
providing a head configured to deliver a composite material band;
a compaction roller operative to apply pressure to the composite material band; and
a counter-pressure roller operative to accept the composite material band and resist the pressure applied by the compaction roller to the composite material band;
wherein the composite material band is directed into a nip between the compaction roller and the counter-pressure roller, forming a composite material tubular member.
